(19) United States
(12) Patent Application Publication
(10) Pub. No.: US 2010/0100417 A1
(43) Pub. Date: Apr. 22, 2010

(54) COMMERCIAL INCENTIVE PRESENTATION SYSTEM AND METHOD

(75) Inventors: Dale A. Nussel, Mahomet, IL (US); Allie K. Watfa, Urbana, IL (US)

Correspondence Address: FIALA & WEAVER, P.L.L.C.;C/O CPA GLOBAL, P.O. BOX 52050, MINNEAPOLIS, MN, 55402, US

(73) Assignee: YAHOO! INC., Sunnyvale, CA (US)

(21) Appl. No.: 12/254,213

(22) Filed: Oct. 20, 2008

(51) Int. Cl. G06Q 30/00; G06F 17/30; G06Q 10/00

(52) U.S. Cl. 705/10; 705/14.23

(57) ABSTRACT

A system and method is described that tracks the behavior of a user interacting with an information retrieval system, such as an Internet search engine, and selectively determines whether or not to present a commercial incentive to the user based on the tracked behavior. The system and method may limit the number of times that a commercial incentive is presented to an eligible user, thereby creating a strong incentive for the user to utilize the commercial incentive. The system and method may also assess a level of interest of the user in subject matter associated with the commercial incentive based on the tracked behavior and dynamically determine one or more terms of the commercial incentive based on the assessment.

### BACKGROUND OF THE INVENTION

1. Field of the Invention

The present invention relates to systems and methods that enable commercial incentives to be presented to users via a computer network, such as the Internet.

2. Background

Online advertising refers to the delivery of advertising content via a network, such as the Internet. Such advertising content may be inserted within Web pages, e-mails, or other documents or communications delivered to users via the Internet. Online advertising provides a number of advantages as compared to other conventional forms of advertising. These advantages include, among others, the ability to reach a massive and growing global audience of users at an extremely fast rate, the ability to perform highly-targeted and personalized marketing, and the ability to immediately capitalize on user interest by providing a direct link to an advertiser's Web site. Due to advantages such as these, the market for the placement of online advertisements (“ads”) has grown rapidly in recent years as more and more companies are setting aside marketing budget for online advertising.

A primary goal of many online ads is to encourage a user to click on a link to an advertiser Web site where the user may learn about or actually purchase a product or service. Under conventional online ad purchasing agreements, both the advertiser and the publisher of an online ad stand to benefit when a user clicks on such a link. The advertiser stands to because the user is more likely to purchase the product or service-an act which is sometimes referred to as a “conversion.” The publisher stands to benefit because payments received by the publisher from the advertiser are typically tied to the number of clicks or conversions generated by the online ad.

To increase click-through rates, some advertisers may include a description of a commercial incentive within an online ad. Such language may describe, for example, a discount on a product or service, a sales promotion associated with a product or service, or the like. However, online ads that describe such incentives are typically displayed to users repeatedly, whenever some basic conditions for display are satisfied (for example, whenever the user visits a particular Web site or executes a search using certain search terms). This has the unfortunate effect of eliminating any sense of urgency on the part of the user to investigate the incentive. Furthermore, such incentives are typically not tied to a particular publisher Web site or service and thus do not drive traffic to the Web site or service.

Additionally, online ads that describe commercial incentives are currently not delivered to a user based on an individualized assessment of the user's level of interest in a product or service. For example, online ads in the form of sponsored search results are typically displayed to any user that executes an Internet search that includes certain search terms. Furthermore, the value of a commercial incentive described in an online ad is typically not tied in any way to an individualized assessment of the user's level of interest in a product or service. Taken together, these factors comprise limitations on the degree to which an advertiser can control the distribution and value of commercial incentives described within an online ad.

What is needed then is a system and method for presenting commercial incentives to users via a computer network, such as the Internet, that addresses one or more of the shortcomings associated with conventional systems and methods for performing that function.

### BRIEF SUMMARY OF THE INVENTION

An embodiment of the present invention tracks the behavior of a user interacting with an information retrieval system, such as an Internet search engine, and selectively determines whether or not to present a commercial incentive to the user based on the tracked behavior. The tracked behavior may include, for example, the number of times the user has executed a search based on certain keywords associated with the commercial incentive or the amount of time the user has spent browsing search results generated based on certain keywords associated with the commercial incentive.

An embodiment of the present invention may also limit the number of times that a commercial incentive is presented to an eligible user, thereby creating a strong incentive for the user to utilize the commercial incentive. Utilizing the incentive may include clicking on a hyperlink to an advertiser Web site included within the commercial incentive.

An embodiment of the present invention may also assess a level of interest of the user in subject matter associated with the commercial incentive based on the tracked behavior and then dynamically determine one or more terms of the commercial incentive based on the assessment. Such terms of the commercial incentives may include but are not limited to a discount amount, a rebate amount, a reward amount, or an identification of an additional product or service to be delivered to the user upon redemption of the commercial incentive.

In particular, a method for providing a commercial incentive to a user of a computer is described herein. In accordance with the method, behavior of the user when interacting with an information retrieval system via a user interface of the computer is tracked. A commercial incentive is then selectively presented for display to the user via the user interface of the computer based on the tracked behavior. Redemption of the commercial incentive on behalf of the user is then facilitated responsive to determining that the user has activated an interactive component of the commercial incentive when displayed via the user interface of the computer.

In accordance with one embodiment of the forgoing method, tracking the behavior of the user when interacting with the information retrieval system includes tracking an amount of time that the user spends browsing search results generated by the information retrieval system and selectively presenting the commercial incentive for display to the user based on the tracked behavior includes presenting the commercial incentive for display to the user responsive to at least determining that the tracked amount of time exceeds a predefined amount of time.

In accordance with another embodiment of the foregoing method, tracking the behavior of the user when interacting with the information retrieval system includes tracking a number of search requests that have been submitted by the user to the information retrieval system and selectively presenting the commercial incentive for display to the user based on the tracked behavior includes presenting the commercial incentive for display to the user responsive to at least determining that the tracked number of search requests exceeds a predefined number of search requests.

In accordance with a further embodiment of the foregoing method, presenting the commercial incentive for display to the user includes presenting the commercial incentive within a search results page generated by the information retrieval system for display to the user and determining that the user has activated the interactive component of the commercial incentive includes determining that the user has activated a hyperlink.

In accordance with a still further embodiment of the foregoing method, selectively presenting a commercial incentive for display to the user via the user interface of the computer based on the tracked behavior includes selectively presenting the commercial incentive for display to the user via the user interface of the computer based on the tracked behavior provided that a total number of times that the commercial incentive was previously presented for display via the user interface of the computer does not equal a predefined limit.

The foregoing method may further include calculating an interest level of the user based on the tracked behavior and determining at least one term of the commercial incentive based on the calculated interest level of the user.

An information retrieval system is also described herein. The information retrieval system includes a page server, a search results generator, and a commercial incentive server. The page server is configured to enable a user to interact with the information retrieval system via a user interface of a computer and to track behavior of the user when interacting with the information retrieval system, wherein such interaction includes submitting search requests to the information retrieval system and browsing search results generated by the information retrieval system. The search results generator is configured to generate search results based on search requests submitted by the user. The commercial incentive server is configured to select commercial incentives for display to the user based on the tracked behavior. The page server is further configured to present search results generated by the search results generator and commercial incentives selected by the commercial incentive server to the user via the user interface of the computer and to facilitate redemption of at least one commercial incentive on behalf of the user responsive to determining that the user has activated an interactive component of the at least one commercial incentive when displayed via the user interface of the computer.

In one implementation of the foregoing system, the page server is configured to track an amount of time that the user spends browsing search results presented to the user by the page server and the commercial incentive server is configured to select a commercial incentive for display to the user responsive to at least determining that the tracked amount of time exceeds a predefined amount of time.

In another implementation of the foregoing system, the page server is configured to track a number of search requests that have been submitted by the user and the commercial incentive server is configured to select a commercial incentive for display to the user responsive to at least determining that the tracked number of search requests exceeds a predefined number of search requests.

In yet another implementation of the foregoing system, the page server is configured to present search results generated by the search results generator and a commercial incentive selected by the commercial incentive server to the user within a search results page and to facilitate redemption of the commercial incentive on behalf of the user responsive to determining that the user has activated a hyperlink of the commercial incentive.

In a further implementation of the foregoing system, the commercial incentive server is configured to select a commercial incentive for display to the user based on the tracked behavior provided that a total number of times that the commercial incentive was previously presented to the user via the user interface of the computer does not equal a predefined limit.

In a still further implementation of the foregoing system, the commercial incentive server is further configured to calculate an interest level of the user based on the tracked behavior and to determine at least one term of a commercial incentive based on the calculated interest level of the user.

An alternative method for providing a commercial incentive to a user of a computer is also described herein. In accordance with the method, an interest level of a user is determined based on tracked behavior of the user when interacting with an information retrieval system via a user interface of a computer. At least one term of a commercial incentive is then determined based on the determined interest level of the user. The commercial incentive is then presented for display to the user via the user interface of the computer.

An alternative information retrieval system is also described herein. The information retrieval system includes a page server and a commercial incentive server. The page server is configured to enable a user to interact with the information retrieval system via a user interface of a computer and to track behavior of the user when interacting with the information retrieval system. The commercial incentive server is configured to determine an interest level of the user based on the tracked behavior of the user and to determine at least one term of a commercial incentive based on the determined interest level of the user. The page server is further configured to present the commercial incentive for display to the user via the user interface of the computer.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of a system that enables an advertiser to submit a commercial incentive for presentation to a user in accordance with an embodiment of the present invention.

FIG. 2 depicts a flowchart of a method by which an advertiser may submit a commercial incentive for presentation to a user in accordance with an embodiment of the present invention.

FIG. 3 is a block diagram of a system that selectively presents commercial incentives to users in accordance with an embodiment of the present invention.

FIG. 4 depicts a flowchart of a method for selectively presenting a commercial incentive to a user of an information retrieval system in accordance with an embodiment of the present invention.

FIG. 5 depicts a flowchart of a method for limiting the number of times that a commercial incentive is presented to a user in accordance with an embodiment of the present invention.

FIG. 6 depicts a flowchart of a method for dynamically determining at least one term of a commercial incentive to be presented to a user in accordance with an embodiment of the present invention.

FIG. 7 depicts a graph that shows how the term of a commercial incentive may be determined dynamically based on the calculated interest level of a user in accordance with one embodiment of the present invention.

FIG. 8 illustrates a portion of a search results page that does not include a commercial incentive that may be generated by an information retrieval system in accordance with an embodiment of the present invention.

FIGS. 9 and 10 each illustrate a portion of a search results page that includes commercial incentives and that may be generated by an information retrieval system in accordance with an embodiment of the present invention.

FIG. 11 is a block diagram of a computer system that may be used to implement one or more aspects of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

An embodiment of the present invention tracks the behavior of a user interacting with an information retrieval system, such as an Internet search engine, and selectively determines whether or not to present a commercial incentive to the user based on the tracked behavior. The tracked behavior may include, for example, the number of times the user has executed a search based on certain keywords associated with the commercial incentive or the amount of time the user has spent browsing search results generated based on certain keywords associated with the commercial incentive.

An embodiment of the present invention may also limit the number of times that a commercial incentive is presented to an eligible user, thereby creating a strong incentive for the user to utilize the commercial incentive. Utilizing the incentive may include clicking on a hyperlink to an advertiser Web site included within the commercial incentive.

An embodiment of the present invention may also assess a level of interest of the user in subject matter associated with the commercial incentive based on the tracked behavior and then dynamically determine one or more terms of the commercial incentive based on the assessment. Such terms of the commercial incentives may include but are not limited to a discount amount, a rebate amount, a reward amount, or an identification of an additional product or service to be delivered to the user upon redemption of the commercial incentive.

The present invention may be used within the context of an information retrieval system, such as an Internet search engine, to selectively provide commercial incentives to users. This may advantageously attract users to use the information retrieval system and increase a click through rate associated with such users. As noted in the Background section above, increased click through rates can benefit both the advertisers submitting the commercial incentives and the entity administering the information retrieval system, which acts as the publisher of the commercial incentives. A portion of any financial benefit accruing to the entity administering the information retrieval system due to the increased click through rates could optionally be used to offset the cost of the commercial incentives to the advertisers, thereby further incentivizing advertisers to submit commercial incentives for publication via the information retrieval system.

### B. Example Commercial Incentive Presentation System and Method

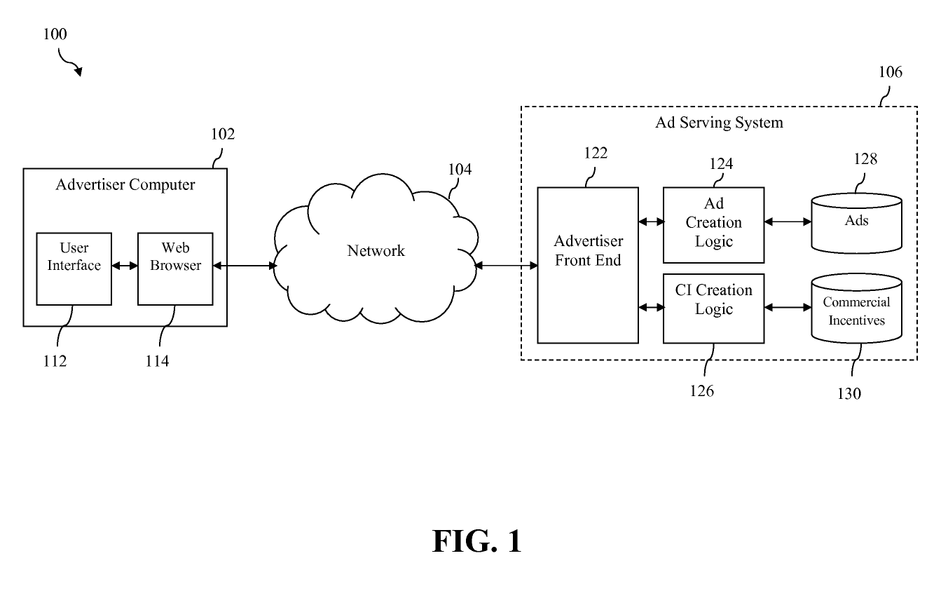

FIG. 1 is a block diagram of an example system 100 that enables an advertiser to submit a commercial incentive for presentation to a user in accordance with an embodiment of the present invention. System 100 may be thought of as one part of a larger commercial incentive delivery system, other aspects of which will be described elsewhere herein. As shown in FIG. 1, system 100 includes an advertiser computer 102 that is communicatively connected to an ad serving system 106 via a network 104.

Advertiser computer 102 is intended to represent any processor-based system or device, such as a personal computer (PC), that that can be used to interact with ad serving system 106. As shown in FIG. 1, advertiser computer 102 includes a number of interconnected components including a user interface 112 and a Web browser 114. User interface 112 comprises one or more components configured to accept input from a user, such as, for example, a keyboard, keypad, mouse and/or touch-sensitive display screen. User interface 112 further comprises one or more components configured to provide output to a user, such as, for example, a display screen and/or one or more audio speakers. Web browser 114 comprises a software application that enables a user to access information and services available via network 104.

In one embodiment, network 104 comprises the Internet. However, the invention is not so limited, and network 104 may comprise any type of network or combination of networks including wide area networks, local area networks, private networks, public networks, packet networks, circuit-switched networks, and wired or wireless networks.

Ad serving system 106 comprises a system that is configured to facilitate the submission of ads and commercial incentives by advertisers and the presentation of such ads and commercial incentives to users of a computer network, such as the Internet. Certain components of ad serving system 106 that specifically relate to the submission of ads and commercial incentives are shown in FIG. 1. These components include an advertiser front end 122, ad creation logic 124, an ads database 128, commercial incentive (CI) creation logic 126, and a commercial incentives database 130.

Advertiser front end 122 comprises logic that is configured to present a network-accessible interface by which advertisers, such as an advertiser using advertiser computer 102, can create ads and commercial incentives for subsequent presentation to users. The network-accessible interface may comprise, for example, a series of Web pages designed both to provide information to and receive information from an advertiser. Such Web pages may be delivered, for example, to Web browser 114 of advertiser computer 102 for display via user interface 112. An advertiser may enter data into such Web pages using user interface 112, and Web browser 114 will deliver such entered data to advertiser front end 122. The use of Web pages to provide information to and obtain information from a user of a networked computer in this manner is well-known in the art.

Ad creation logic 124 comprises logic that is configured to use or interpret data provided by an advertiser via advertiser front end 122 to generate an ad for subsequent presentation to users. Depending upon the implementation, ads generated by ad creation logic 124 may comprise text, graphic, audio and/or video content. Examples of ads that may be generated by ad creation logic 124 include, but are not limited to, sponsored search results, contextual ads, banner ads, floating ads, expanding ads, polite ads, wallpaper ads, trick banners, pop-up ads, pop-under ads, video ads, map ads, mobile ads and streaming audio/video ads. Ads generated by ad creation logic 124 are stored in ads database 128 for subsequent presentation to users.

CI creation logic 126 comprises logic that is configured to use or interpret data provided by an advertiser via advertiser front end 122 to generate a commercial incentive for subsequent presentation to users. Depending upon the implementation, commercial incentives generated by CI creation logic 126 may comprise text, graphic, audio and/or video content. Commercial incentives generated by CI creation logic 126 are stored in commercial incentives database 130 for subsequent presentation to users in a manner that will be described in more detail herein.

Advertiser front end 122 is also configured to obtain information from an advertiser that is used to determine when a commercial incentive submitted by the advertiser should be presented to a user. Such information may be stored in association with the commercial incentive in commercial incentives database 130.

Advertiser front end 122, ad creation logic 124 and CI creation logic 126 may be implemented as software and collectively executed on a single server computer. Alternatively, each of these elements may be implemented as software and executed on different server computers within a plurality of interconnected server computers. Furthermore, although ads database 128 and commercial incentives database 130 are each shown as a single database in FIG. 1, it is to be understood that depending on volume, the data stored in each of those databases may actually be stored across numerous databases.

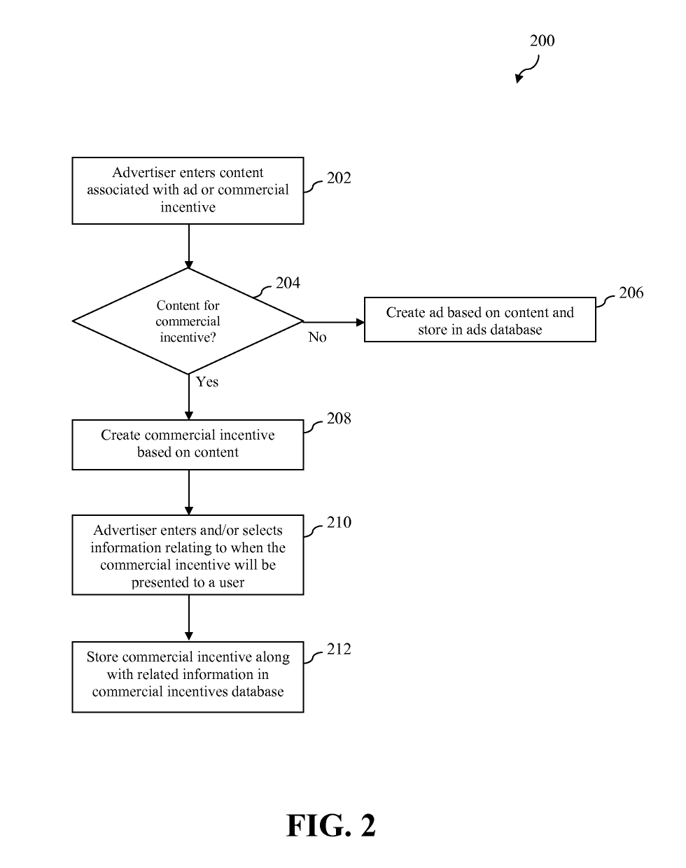

FIG. 2 depicts a flowchart 200 of a method by which an advertiser may submit a commercial incentive for presentation to a user in accordance with an embodiment of the present invention. The method of flowchart 200 will now be described with continued reference to system 100 of FIG. 1, although the method is not limited to that implementation.

As shown in FIG. 2, the method of flowchart 200 begins at step 202 in which an advertiser, using user interface 112 of advertiser computer 102, submits content associated with an ad or commercial incentive to ad serving system 106. For example, the advertiser may submit such content via a Web-based interface provided by advertiser front end 122 and displayed to the advertiser by Web browser 114. The content may comprise one or more of text, graphic, audio or video content.

At decision step 204, advertiser front end 122 determines whether the content submitted during step 202 should be used to create an ad or a commercial incentive. In one embodiment, advertiser front end 122 makes this determination responsive to input from the advertiser. For example, the advertiser may specify whether the content should be used to create an ad or a commercial incentive by clicking on a button or activating some other user interface element within a Web page provided by advertiser front end 122 and displayed by Web browser 114.

If advertiser front end 122 determines during step 204 that the content submitted during step 202 should be used to create an ad, then ad creation logic 124 is invoked to create an ad based on the content and the ad is stored in ads database 128 for subsequent presentation to users as shown at step 206.

However, if advertiser front end 122 determines that the content submitted during step 202 should be used to create a commercial incentive, then CI creation logic 126 is invoked to create a commercial incentive based on the content as shown at step 208. Processing then proceeds to step 210.

At step 210, advertiser front end 122 provides the advertiser with an interface by which the advertiser enters or selects certain information that will be used to determine when the commercial incentive should be presented to a user. In an embodiment, this information includes one or more search keywords to be associated with the commercial incentive, a predefined amount of time that a user must spend browsing search results generated based on any of the specified keywords before the commercial incentive may be shown (referred to herein as TimeInSearchThreshold) and a predefined number of times that a user must submit a search request using any of the specified keywords before the commercial incentive may be shown (referred to herein as VisitSearchTermThreshold).

In a further embodiment of the present invention in which the value of a commercial incentive term may be tied to an interest level of the user, the advertiser may also provide the following information during step 208: a weighting factor to be applied to TimeInSearchThreshold when calculating the interest level, a weighting factor to be applied to VisitSearchTermThreshold when calculating the interest level, different values corresponding to a term of the commercial incentive, and an interest level range within which each of the different values corresponding to the term of the commercial incentive should be applied.

At step 212, the commercial incentive created during step 208 and the associated information provided by the advertiser during step 210 are stored in commercial incentives database 130. The data stored in database 130 is then used in a manner to be described in more detail herein to selectively present commercial incentives to users.

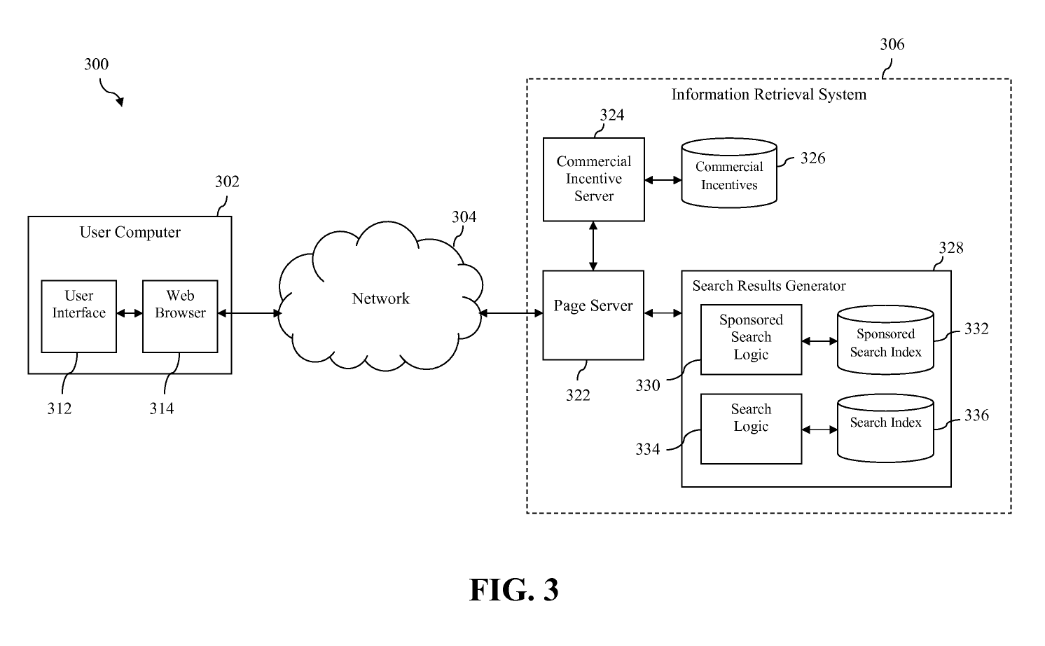

FIG. 3 is a block diagram of an example system 300 that selectively presents commercial incentives to users in accordance with an embodiment of the present invention. As shown in FIG. 3, system 300 includes a user computer 302 that is communicatively connected to an information retrieval system 306 via a network 304.

User computer 302 is intended to represent any processor-based system or device that can be used to access information retrieval system 306 via network 304. For example, user computer 302 may comprise a desktop computer, laptop computer, tablet computer, gaming console, personal digital assistant (PDA), media player, or cellular telephone, although these examples are not intended to be limiting.

As shown in FIG. 3, user computer 302 includes a number of interconnected components including a user interface 312 and a Web browser 314. User interface 312 comprises one or more components configured to accept input from a user, such as, for example, a keyboard, keypad, mouse and/or touch-sensitive display screen. User interface 312 further comprises one or more components configured to provide output to the user, such as, for example, a display screen and/or one or more audio speakers. Web browser 314 comprises a software application that enables a user to access information and services available via network 304.

In one embodiment, network 304 comprises the Internet. However, the invention is not so limited, and network 304 may comprise any type of network or combination of networks including wide area networks, local area networks, private networks, public networks, packet networks, circuit-switched networks, and wired or wireless networks.

Information retrieval system 306 comprises a system that is configured to receive a search request from a user, such as a user of user computer 302, via network 304 and to provide search results responsive thereto, wherein the search results identify documents or other types of content available to the user via network 304 that are deemed relevant to the search request. Information retrieval system 306 may provide both search results sponsored by an advertiser (referred to herein as “sponsored search results”) as well as unsponsored search results. Furthermore, information retrieval system 306 may selectively present one or more commercial incentives to a user responsive to user interaction with system 306.

As shown in FIG. 3, information retrieval system 306 includes a plurality of interconnected components including a page server 322, a search results generator 328, a commercial incentive server 324 and a commercial incentives database 326.

Page server 322 comprises logic that is configured to enable a user to interact with information retrieval system 306 via user interface 312 of user computer 302. To perform this function, page server 322 is configured to present Web pages to Web browser 314, which in turn displays the pages to the user via user interface 312. For example, page server 322 may present a Web page that allows a user to submit a search request to information retrieval system 306. Such a request may be submitted by entering one or more search keywords into a designated area of the Web page.

As another example, page server 322 may present search results to the user within the context of a Web page referred to herein as a search results page. A search results page may include, for example, a list of Web pages identified as relevant to the search keywords submitted by the user. The identified Web pages may be ordered from most relevant to least relevant. For each Web page identified in the search results page, the following information may be provided: a title associated with the Web page, an abstract that summarizes the content of the Web page, and a Uniform Resource Locator (URL) associated with the Web page. The title may also comprise a hyperlink to the identified Web page.

Page server 322 is further configured to forward search requests received from a user to search results generator 328. Search results generator 328 is configured to generate search results based on the search requests. As shown in FIG. 3, search results generator includes both sponsored search logic 330 and search logic 334 for performing this function. Sponsored search logic 330 is configured to search a sponsored search index 332 to identify Web sites sponsored by advertisers that are deemed relevant to the search request while search logic 334 is configured to search a search index to 336 to identify Web sites that are not sponsored by advertisers that are deemed relevant to the search request. Search results provided by both sponsored search logic 330 and search logic 334 are then provided to page server 322 which uses the results to create a search results page for presentation to the user.

Page server 322 is also configured to track the behavior of a user when the user interacts with information retrieval system 306. In particular, page server 322 is configured to track an amount of time that the user spends browsing search results generated by information retrieval system 306 responsive to receiving certain search keywords. Furthermore, page server 322 is configured to track a number of search requests that have been submitted by the user to information retrieval system 306 that contain certain search keywords. This information is then used by commercial incentive server 324 to determine whether or not to provide a commercial incentive to the user.

The manner in which commercial incentive server 324 uses such information to selectively provide commercial incentives to a user will be described in detail herein. Commercial incentives provided by commercial incentive server 324 are obtained from commercial incentives database 326. Commercial incentives database 326 may be populated with commercial incentives in a like manner to that described above with respect to commercial incentives database 130 of FIG. 1.

In one embodiment, page server 322 is configured to incorporate commercial incentives selected by commercial incentive server 324 into a search results page for presentation to a user. Page server 322 may also be configured to track whether or not the user has activated an interactive component, such as a hyperlink, of each commercial incentive presented to the user in order to facilitate redemption of the commercial incentive on behalf of the user.

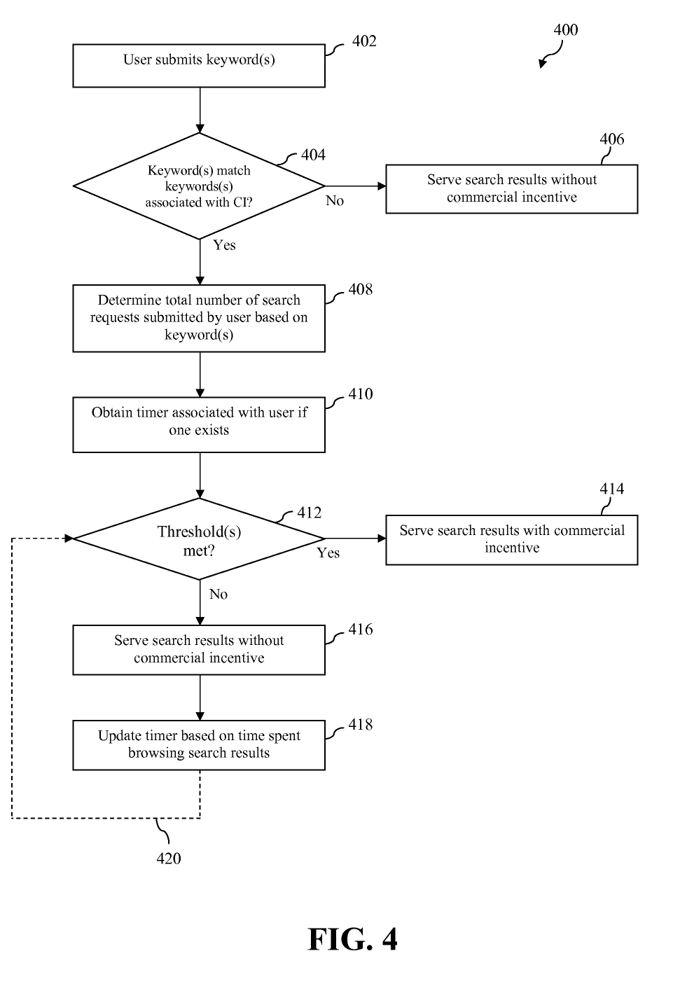

FIG. 4 depicts a flowchart 400 of a method for selectively presenting a commercial incentive to a user of an information retrieval system in accordance with an embodiment of the present invention. The method of flowchart 400 will now be described with continued reference to system 300 of FIG. 3, although the method is not limited to that implementation.

As shown in FIG. 4, the method of flowchart 400 begins at step 402 in which a user, such as a user of user computer 302, submits one or more search keywords to information retrieval system 306. The user may perform this step by entering the keyword(s) into a designated area of a Web page served by page server 322 and displayed by Web browser 314. The keyword(s) are then transmitted to page server 322 via network 304. Page server 322 provides a copy of the keyword(s) to commercial incentive server 324 and also to search results generator 328, which generates search results based on the keyword(s).

At step 404, commercial incentive server 324 determines whether or not the keyword(s) submitted in step 402 are associated with a commercial incentive stored in commercial incentives database 326. One manner by which an advertiser may associate keywords with a commercial incentive was described above in reference to flowchart 200 of FIG. 2. If commercial incentive server 324 determines that no such association exists, then page server 322 builds a search results page that includes the search results generated by search results generator 328 but that does not include any commercial incentive. Page server 322 then serves the search results page to the user. This is shown at step 406.

However, if commercial incentive server 324 determines that the keyword(s) submitted in step 402 are associated with a commercial incentive stored in commercial incentives database 326, then processing proceeds to step 408.

At step 408, commercial incentive server 324 determines a total number of search requests that have been submitted by the user based on the keyword(s) submitted in step 402. In an embodiment, this number is tracked by page server 322 and provided to commercial incentive server 324. By tracking the number of times a user has executed a search based on certain keywords, an embodiment of the present invention can ascertain an extent to which the user has shown an interest in subject matter deemed related to the keywords. For example, a user that has executed a large number of searches using the keywords “computer games” may be assumed to have a high level of interest in computer games.

In one embodiment, the total number of search requests determined in step 408 encompasses search requests based on the keyword(s) submitted in step 402 as well as other search requests submitted by the same user that are deemed related to the same or similar subject matter. By way of example, the total number of search requests may include the total number of search requests that have been executed by the user based on the keywords “computer games” as well as the total number of search requests that have been executed by the user based on the keywords “video games,” since those keywords may be deemed related to the same subject matter.

Depending upon the implementation, the tracking of search requests submitted by a user may be premised on tracking search requests submitted by a particular Internet Protocol (IP) address or other identifier uniquely associated with a user computer. Alternatively, the tracking of search requests submitted by a user may be premised on tracking search requests submitted by a person logged into information retrieval system 306 using a particular user ID. Other methods for tracking search requests submitted from a particular computer or by a particular user may be used.

At step 410, commercial incentive server 324 obtains a timer associated with the user, wherein the timer indicates a cumulative amount of time that the user has spent browsing search results generated by information retrieval system 306 based on the keyword(s) submitted in step 402. The amount of time may be represented in minutes, seconds, or any other suitable increment. If such a timer does not exist, then one will be initiated during this step. In an embodiment, this timer is initiated and incremented by page server 322 and provided to commercial incentive server 324. By tracking the cumulative amount of time a user has spent browsing search results generated based on certain keywords, an embodiment of the present invention can further determine an extent to which the user has shown an interest in subject matter deemed related to the keywords. For example, a user that has spent a large amount of time browsing search results generated based on the keywords “computer games” may be assumed to have an interest in computer games.

In one embodiment, the timer obtained in step 408 accounts for time spent by the user browsing search results generated based on the keyword(s) submitted in step 402 as well as time spent by the user browsing other search results that are deemed related to the same or similar subject matter. By way of example, the timer obtained in step 408 may account for the total amount of time spent by the user browsing search results generated based on the keywords “computer games” as well as the total amount of time spent by the user browsing search results generated based on the keywords “video games,” since those keywords may be deemed related to the same subject matter.

Depending upon the implementation, the tracking of an amount of time spent by a user browsing search results may be premised on tracking the amount of time a particular Internet Protocol (IP) address or other identifier uniquely associated with a user computer is determined to be browsing the search results. Alternatively, the tracking of an amount of time spent by a user browsing search results may be premised on tracking the amount of time that a person logged into information retrieval system 306 using a particular user ID is determined to be browsing the search results. Other methods for tracking the amount of time spent by a particular user browsing search results may be used.

At decision step 412, commercial incentive server 324 compares the total number of search requests that have been submitted by the user based on the relevant keyword(s) as determined in step 408, which is referred to herein as IPvisit, to a predefined number of search requests associated with the commercial incentive, which is referred to herein as VisitSearchTermThreshold. During decision step 412, commercial incentive server 324 also compares the cumulative amount of time that the user has spent browsing search results generated based on the relevant keyword(s) as obtained in step 410, which is referred to herein as TimeInSearchResults, to a predefined amount of time associated with the commercial incentive, which is referred to herein as TimeInSearchThreshold. One manner in which the threshold values VisitSearchTermThreshold and TimeInSearchThreshold may be set by an advertiser and associated with a commercial incentive was described above in reference to flowchart 200 of FIG. 2.

If commercial incentive server 324 determines that IPvisit is greater than or equal to VisitSearchTermThreshold or that TimeInSearchResults is greater than or equal to TimeInSearchThreshold, then at least one of the threshold conditions for presenting the commercial incentive to the user has been met. In this case, commercial incentive server 324 provides the commercial incentive to page server 322. Page server 322 then generates a search results page that includes both the search results generated by search results generator 328 and the commercial incentive and serves the search results page to the user. This is shown at step 414.

However, if commercial incentive server 324 determines that Ipvisit is less than VisitSearchTermThreshold and that TimeInSearchResults is less than TimeInSearchThreshold, then neither of the threshold conditions for presenting the commercial incentive to the user has been met. In this case, commercial incentive server 324 does not provide the commercial incentive to page server 322.

Consequently, page server 322 builds a search results page that includes the search results generated by search results generator 328 but that does not include any commercial incentive. Page server 322 then serves the search results page to the user. This is shown at step 416.

After the search results page has been served to the user at step 416, the user may spend time browsing the search results page. During this time, page server 322 will increment the TimeInSearchResults value accordingly as shown at step 418.

Depending upon the implementation, the test of decision step 412 may not be repeated again for the same user and the same commercial incentive until such time as the user submits another search request to information retrieval system 306 that includes one or more keywords associated with the commercial incentive. However, in an alternate embodiment, commercial incentive server 324 may periodically perform the test of decision step 412 while the user continues to browse the search results page served during step 416. As the user browses the search results page, the value of TimeInSearchResults may increase such that it meets or exceeds the threshold value TimeInSearchThreshold associated with the commercial incentive. When this occurs, commercial incentive server 324 may cause the commercial incentive to be served to the user in the form of an updated search results page. This latter implementation is intended to be represented by dashed line 420 connecting step 418 to decision step 412 in flowchart 400.

It should be noted that the keyword(s) submitted by the user during step 402 may be associated with only a single commercial incentive stored in commercial incentives database 326 or may be associated with a plurality of different commercial incentives stored in commercial incentives database 326. For example, in one implementation, an advertiser may have the exclusive right to deliver a commercial incentive when certain search terms are submitted to information retrieval system 306. In an alternate implementation, multiple advertisers may be able to deliver a commercial incentive when the same search terms are submitted to information retrieval system 306. In this latter implementation, page server 322 may utilize a ranking algorithm to determine where each of the different commercial incentives should appear within a given search results page.

In an embodiment in which multiple commercial incentives can be associated with the same search term(s), it is to be understood that the process flow beginning at step 408 of flowchart 400 may be executed once for each commercial incentive identified during decision step 404 as being associated with the keyword(s) submitted during step 402.

By permitting an advertiser to select the threshold values associated with a commercial incentive used during decision step 412, the foregoing method advantageously permits an advertiser to control the point at which the commercial incentive will be shown to a particular user. For example, if the advertiser sets VisitSearchTermThreshold to 1 or sets TimeInSearch to 0, then the commercial incentive will be immediately shown to any user that submits the search keyword(s) associated with the commercial incentive. However, by increasing both these thresholds, the advertiser can ensure that the commercial incentive is only presented to those users that have shown an increased level of interest in the subject matter associated with the search keyword(s), by either executing a certain number of searches based on the keyword(s) or spending a certain amount of time browsing search results generated based on the keyword(s).

In a further embodiment of the present invention, the advertiser can also advantageously limit the number of times that a commercial incentive will be presented to a particular user. By so doing, the advertiser can create a strong incentive for the user to perform some action with respect to the commercial incentive, such as clicking on a link to an advertiser Web site included within the commercial incentive. For example, the advertiser may create a commercial incentive in the form of a “one-time-only offer” that will be presented to a user only once and that can only be redeemed by the user by clicking on a link to the advertiser's Web site included in the commercial incentive.

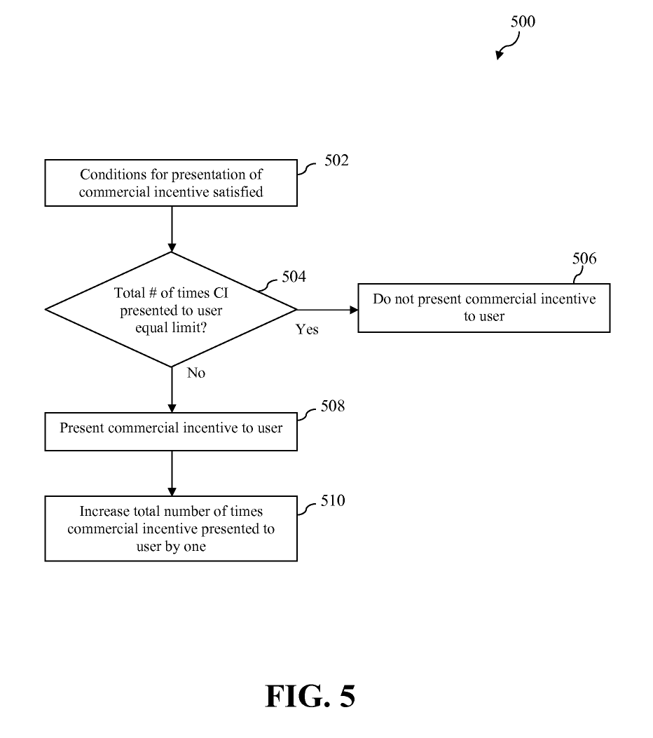

FIG. 5 depicts a flowchart 500 of a method for limiting the number of times that a commercial incentive is presented to a user in accordance with an embodiment of the present invention. The method of flowchart 500 will now be described with continued reference to system 300 of FIG. 3, although the method is not limited to that implementation.

As shown in FIG. 5, the method of flowchart 500 begins at step 502, during which commercial incentive server 324 determines that certain conditions for presenting a commercial incentive to a user have been satisfied. The conditions may be, for example, those described above in reference to decision step 412 of flowchart 400.

At decision step 504, commercial incentive server 324 compares a total number of times that the commercial incentive has been presented to the user to a presentation limit associated with the commercial incentive. The total number of times that the commercial incentive has been presented to the user may be tracked by commercial incentive server 324 itself or, alternatively, may be tracked by page server 322 and passed to commercial incentive server 324. The value may be tracked per IP address, per user ID, or per some other identifier associated with a user computer or user. The presentation limit associated with the commercial incentive may be specified by the advertiser when creating or configuring the commercial incentive via an ad serving system, such as ad serving system 100 described above in reference to FIG. 1.

If commercial incentive server 324 determines that the total number of times that the commercial incentive has been presented to the user matches the presentation limit associated with the commercial incentive, then commercial incentive server 324 will not provide the commercial incentive for presentation to the user as shown at step 506.

However, if commercial incentive server 324 determines that the total number of times that the commercial incentive has been presented to the user is less than the presentation limit associated with the commercial incentive, then commercial incentive server 324 will provide the commercial incentive for presentation to the user as shown at step 508. Commercial incentive server 324 or page server 322 will then increase the total number of times that the commercial incentive has been presented to the user by one, as shown at step 510.

In a still further embodiment of the present invention, commercial incentive server 324 may be configured to dynamically determine at least one term of a commercial incentive to be presented to a user based on an ascertained interest level of the user. Terms of a commercial incentive that may be determined in this manner include but are not limited to a discount amount (expressed in terms of an amount of money or percentage of a price), a rebate amount, a reward amount (e.g., airline miles), or an identification of an additional product or service to be delivered to the user upon redemption of the commercial incentive. Other terms that may be determined in this manner also include but are not limited to an identification of the product or service to which the commercial incentive relates or an incentive model (e.g., discount, rebate, “buy one get one free”, etc.). Among other advantages, this feature allows an advertiser to calibrate the value of a commercial incentive to the level of interest of the user to whom the commercial incentive is being presented.

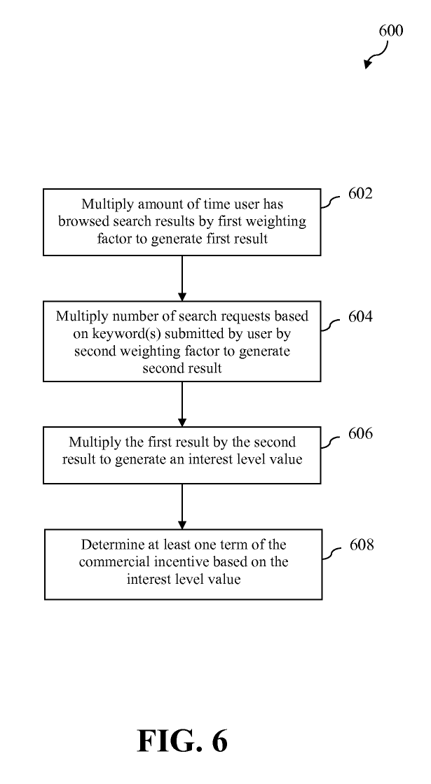

FIG. 6 depicts a flowchart 600 of a method for dynamically determining at least one term of a commercial incentive to be presented to a user in accordance with an embodiment of the present invention. The method of flowchart 600 will now be described with continued reference to system 300 of FIG. 3, although the method is not limited to that implementation.

In one implementation, the method of flowchart 600 is performed by commercial incentive server 324 after that server has determined that certain conditions for presenting a commercial incentive to a user (such as those described above in reference to decision step 412 of flowchart 400) have been satisfied and after commercial incentive server 324 has determined that the commercial incentive to be presented to the user includes at least one term that is to be dynamically determined.

As shown in FIG. 6, the method of flowchart 600 begins at step 602 in which commercial incentive server 324 multiplies a cumulative amount of time that the user has spent browsing search results generated based on search keyword(s) associated with the commercial incentive (TimeInSearchResults) by a first weighting factor to generate a first result.

At step 604, commercial incentive server 324 multiplies a total number of search requests that have been submitted by the user based on search keyword(s) associated with the commercial incentive (IPvisit) by a second weighting factor to generate a second result.

In one embodiment, the first weighting factor used in step 602 and the second weighting factor used in step 604 are each specified by an advertiser when creating or configuring the commercial incentive via an ad serving system, such as ad serving system 100 described above in reference to FIG. 1. This advantageously allows the advertiser to determine the level of significance to be attributed to the TimeInSearchResults parameter and the IPvisit parameter when user interest level is ascertained. Alternatively, the first and second weighting factors may be specified by an entity that administers information retrieval system 306 or by some other entity.

At step 606, commercial incentive server 324 multiples the first result generated in step 602 by the second result generated in step 604 to generate a value representative of an interest level of the user.

At step 608, commercial incentive server 324 determines at least one term of the commercial incentive based on the interest level calculated in step 606. In one embodiment, commercial incentive 324 performs this step by determining which of a plurality of ranges the interest level value falls in and by then assigning a value to a commercial incentive term based on the identified range.

For example, in one implementation, an entity that administers information retrieval system 306, or some other entity, identifies a total range of values that may be spanned by the interest level value. The range may extend, for example, from some predefined lower limit to some predefined upper limit on the interest level value. The range may be specified, for example, by specifying a single mid-level interest value, wherein the predefined lower limit is equal to 0 and the predefined upper limit is two times the mid-level interest value. An advertiser then specifies different values or other aspects of a commercial incentive term that are to be used depending on where the interest level value generated in step 606 falls within the identified range. The advertiser may specify, for example, that a first value of a commercial incentive term is to be used if the interest level value generated in step 606 is below a certain percentage of the upper limit of the total range of values and that a second value of a commercial incentive is to be used if the interest level value generated in step 606 meets or exceeds that percentage. This would enable, for example, an advertiser to present a commercial incentive that includes a $5.00 discount off of a product if a user shows less than 70% of the highest interest level possible and present a commercial incentive that includes a $10.00 discount off of the product if a user shows 70% or greater of the highest interest level possible.

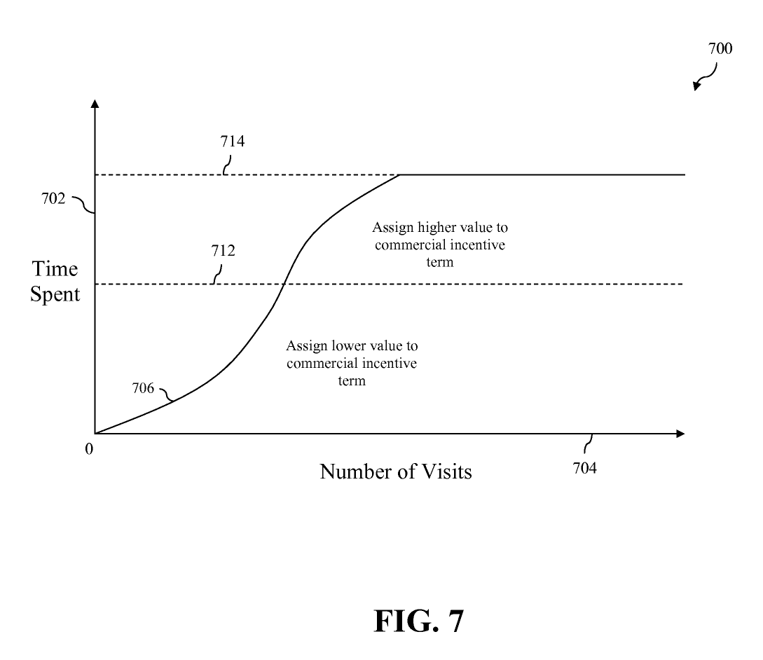

FIG. 7 depicts a graph 700 that shows how the term of a commercial incentive may be determined dynamically based on the calculated interest level of a user in accordance with one embodiment of the present invention. As shown in FIG. 7, the interest level value associated with the user, represented by line 706, increases as certain parameters used to ascertain that interest level value increase. As noted above, these parameters may include a cumulative amount of time that the user has spent browsing search results generated based on search keyword(s) associated with the commercial incentive (TimeInSearchResults) and a total number of search requests that have been submitted by the user based on search keyword(s) associated with the commercial incentive (IPvisit), which are represented on axes 702 and 704 respectively of graph 700. The upper limit of the interest level value is denoted by dashed line 714.

As further shown by graph 700, an advertiser may specify that below a certain interest level value denoted by dashed line 712, a lower value commercial incentive term (e.g., a $5.00 discount) should be used and above that interest level value a higher value commercial incentive term (e.g., a $10.00 discount) should be used. Depending upon the implementation, the interest level value denoted by dashed line 712 may be expressed as a number or as a percentage of the upper limit denoted by dotted line 714. Although graph 700 only shows two interest level value ranges and two corresponding levels of value of a commercial incentive term, persons skilled in the relevant art(s) will readily appreciate that more than two interest level value ranges and corresponding levels of values of a commercial incentive term may be used.

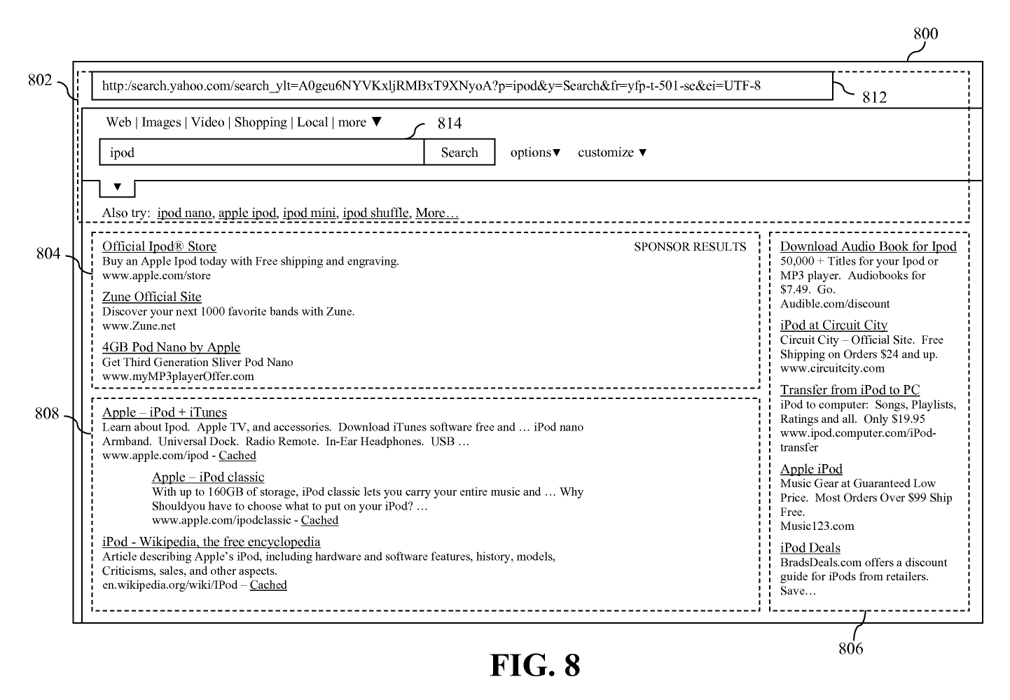

Examples of how an embodiment of the present invention may present commercial incentives to a user within the context of a search results page will now be described with reference to FIGS. 8-10.

In particular, FIG. 8 depicts a portion of a search results page 800 that may be assembled by page server 322 that does not include a commercial incentive. Search results page 800 may be received by Web browser 314 of user computer 302 and displayed to a user via user interface 312. As shown in FIG. 8, search results page 800 includes a header section 802, a first sponsored search results section 804, a second sponsored search results section 806, and a general search results section 808.

Header section 802 includes various elements such as a first user-editable area 812 that includes a URL associated with the search results page and a second user-editable area 814 that includes a search keyword that has been submitted to information retrieval system 306 by a user. As further shown in FIG. 8, the user has submitted the search term “ipod,” which has caused information retrieval system 306 to generate the search results page identified by the URL shown in area 812.

First sponsored search results section 804 and second sponsored search results section 806 each include information about Web pages that have been identified by information retrieval system 306 as associated with the keyword “ipod,” wherein such association exists due to sponsorship by an advertiser. General search results section 808 includes information about Web pages that have been identified by information retrieval system 306 as relevant to the keyword “ipod” based on certain keyword-based search algorithms, wherein such relevancy is not premised on sponsorship by an advertiser. As shown in FIG. 8, for each Web page identified in sections 804, 806 and 808, the following information is provided: a title associated with the Web page, an abstract that summarizes the content of the Web page, and a URL associated with the Web page. The title may also comprise a hyperlink to the identified Web page.

Search results page 800 is intended to represent a search results page that is presented to a user by page server 322 of information retrieval system 306 when commercial incentive server 324 determines that the user is not eligible to receive a commercial incentive associated with the search term “ipod.” For example, commercial incentive server 324 may determine that the user is not eligible to receive a commercial incentive associated with the search term “ipod” because the user has not executed a sufficient number of searches based on the same search term or similar search terms and/or because the user has not spent a sufficient amount of time browsing search results generated based on the same search term or similar search terms.

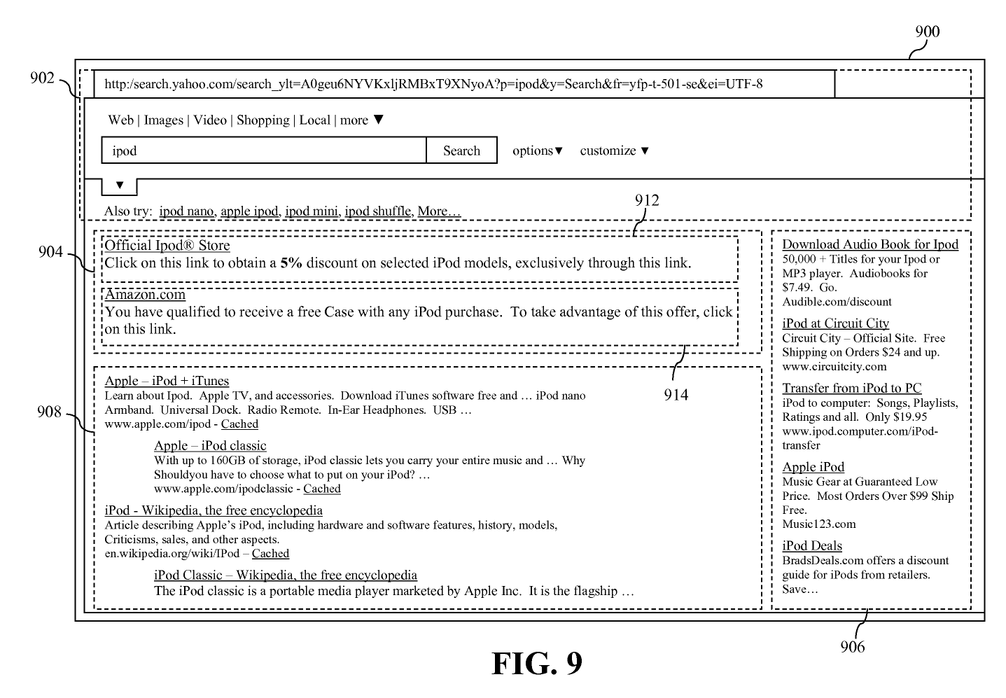

In contrast to FIG. 8, FIG. 9 depicts a portion of a search results page 900 that may be assembled by page server 322 and that includes multiple commercial incentives. Each of the commercial incentives may be included because commercial incentive server 324 has determined that the user has executed a sufficient number of searches based on the search term “ipod” or similar search terms and/or because the user has spent a sufficient amount of time browsing search results generated based on the search term “ipod” or similar search terms. Like search results page 800 of FIG. 8, search results page 900 may be received by Web browser 314 of user computer 302 and displayed to a user via user interface 312.

As shown in FIG. 9, search results page 900 includes a header section 902, a commercial incentive section 904, a sponsored search results section 906, and a general search results section 908. Header section 902, sponsored search results section 906 and general search results section 908 are essentially the same as header section 802, second sponsored search results section 806 and general search results section 808 as described above in reference to search results page 800 of FIG. 8.

Commercial incentive section 904 is a section of search results page 900 that includes commercial incentives that have been selected by commercial incentive server 324 for presentation to the user. Commercial incentives section 904 includes a first commercial incentive 912 and a second commercial incentive 914. Each of commercial incentives 912 and 914 include a title of a Web page with which the commercial incentive is associated (and where the commercial incentive may presumably be redeemed) and a description of the commercial incentive. The title of the Web page also comprises a hyperlink to the Web page. In order to redeem the commercial incentive, the user must click on the hyperlink. When this occurs, page server 322 creates and stores information indicating that the user has clicked on the link. This information may then later be accessed and used by the advertiser to facilitate redemption of the commercial incentive by the user.

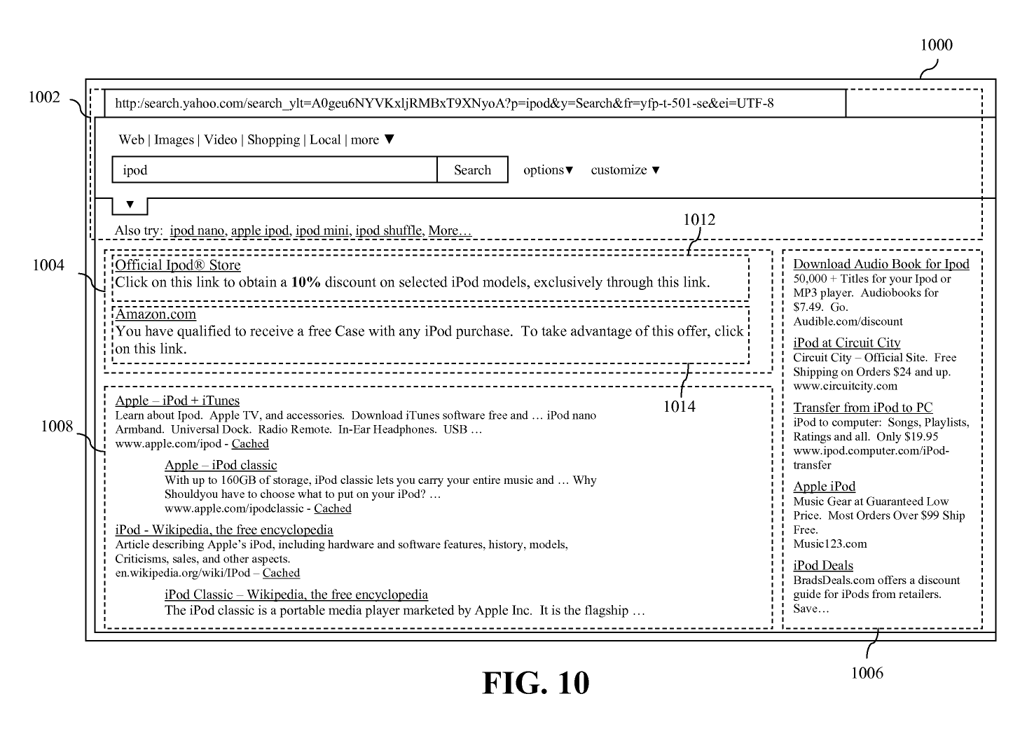

Like FIG. 9, FIG. 10 depicts a portion of a search results page 1000 that may be assembled by page server 322 and that includes multiple commercial incentives.

FIG. 10 is intended to represent a search results page that is assembled under the same circumstances as those that led to the assembly of search results page 900 of FIG. 9, except that the user has demonstrated a higher level of interest in subject matter related to the search term “ipod.” As discussed above, this higher level of interest may have been demonstrated by executing a greater number of searches based on the search term “ipod” or similar search terms and/or by spending a greater amount of time browsing search results generated based on the search term “ipod” or similar search terms.

As shown in FIG. 10, search results page 1000 includes a header section 1002, a commercial incentive section 1004, a sponsored search results section 1006, and a general search results section 1008. Header section 1002, sponsored search results section 1006 and general search results section 1008 are essentially the same as header section 902, sponsored search results section 906 and general search results section 908 as described above in reference to search results page 900 of FIG. 9.

Commercial incentive section 1004 includes commercial incentives that have been selected by commercial incentive server 324 for presentation to the user. Commercial incentives section 1004 includes a first commercial incentive 1012 and a second commercial incentive 1014. Second commercial incentive 1014 is essentially the same as second commercial incentive 914 as described above in reference to search results page 900 of FIG. 9.

First commercial incentive 1012 is similar to first commercial incentive 912 of FIG. 9 except that a term of the commercial incentive has been dynamically changed due to the higher level of interest associated with the user. In particular, as shown in FIG. 10, the 5% discount associated with commercial incentive 912 has been changed to a 10% discount. One manner in which an embodiment of the present invention can dynamically determine a term of a commercial incentive in this manner was described above in reference to flowchart 600 of FIG. 6.

### C. Example Processor-Based Implementation

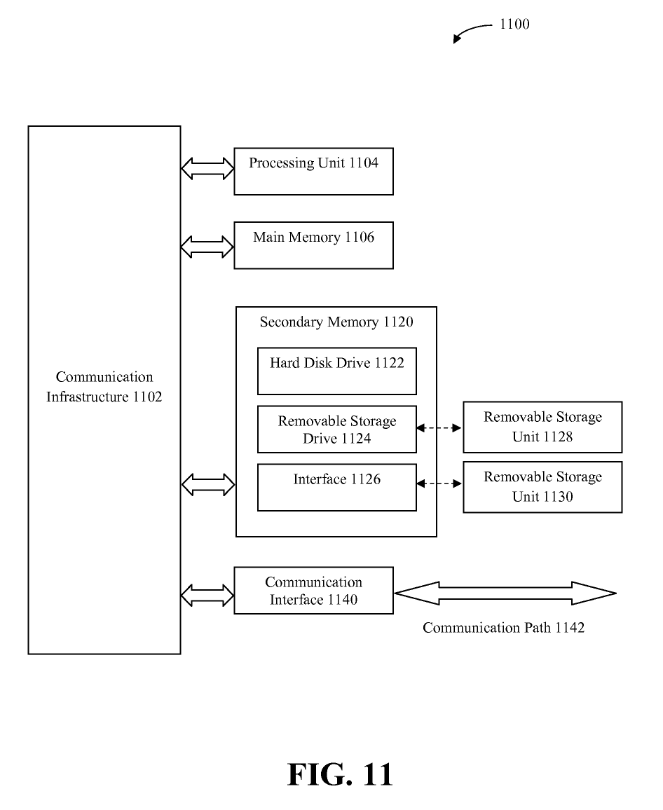

Advertiser computer 102, elements of ad serving system 106, user computer 302, elements of information retrieval system 306, and certain steps of flowcharts 200, 400, 500 and 600 may be implemented by one or more processor-based devices or systems. An example of such a system 1100 is depicted in FIG. 11.

As shown in FIG. 11, system 1100 includes a processing unit 1104 that includes one or more processors. Processor unit 1104 is connected to a communication infrastructure 1102, which may comprise, for example, a bus or a network.

System 1100 also includes a main memory 1106, preferably random access memory (RAM), and may also include a secondary memory 1120. Secondary memory 1120 may include, for example, a hard disk drive 1122, a removable storage drive 1124, and/or a memory stick. Removable storage drive 1124 may comprise a floppy disk drive, a magnetic tape drive, an optical disk drive, a flash memory, or the like. Removable storage drive 1124 reads from and/or writes to a removable storage unit 1128 in a well-known manner. Removable storage unit 1128 may comprise a floppy disk, magnetic tape, optical disk, or the like, which is read by and written to by removable storage drive 1124. As will be appreciated by persons skilled in the relevant art(s), removable storage unit 1128 includes a computer usable storage medium having stored therein computer software and/or data.

In alternative implementations, secondary memory 1120 may include other similar means for allowing computer programs or other instructions to be loaded into system 1100. Such means may include, for example, a removable storage unit 1130 and an interface 1126. Examples of such means may include a program cartridge and cartridge interface (such as that found in video game devices), a removable memory chip (such as an EPROM, or PROM) and associated socket, and other removable storage units 1130 and interfaces 1126 which allow software and data to be transferred from removable storage unit 1130 to system 1100.

System 1100 may also include a communication interface 1140.

Communication interface 1140 allows software and data to be transferred between system 1100 and external devices. Examples of communication interface 1140 may include a modem, a network interface (such as an Ethernet card), a communications port, a PCMCIA slot and card, or the like. Software and data transferred via communication interface 1140 are in the form of signals which may be electronic, electromagnetic, optical, or other signals capable of being received by communication interface 1140. These signals are provided to communication interface 1140 via a communication path 1142. Communications path 1142 carries signals and may be implemented using wire or cable, fiber optics, a phone line, a cellular phone link, an RF link and other communications channels.

As used herein, the terms “computer program medium” and “computer readable medium” are used to generally refer to media such as removable storage unit 1128, removable storage unit 1130 and a hard disk installed in hard disk drive 1122.

Computer program medium and computer readable medium can also refer to memories, such as main memory 1106 and secondary memory 1120, which can be semiconductor devices (e.g., DRAMs, etc.). These computer program products are means for providing software to system 1100.

Computer programs (also called computer control logic, programming logic, or logic) are stored in main memory 1106 and/or secondary memory 1120. Computer programs may also be received via communication interface 1140. Such computer programs, when executed, enable system 1100 to implement features of the present invention as discussed herein. Accordingly, such computer programs represent controllers of the computer system 1100. Where an aspect of the invention is implemented using software, the software may be stored in a computer program product and loaded into system 1100 using removable storage drive 1124, interface 1126, or communication interface 1140.

The invention is also directed to computer program products comprising software stored on any computer readable medium. Such software, when executed in one or more data processing devices, causes a data processing device(s) to operate as described herein. Embodiments of the present invention employ any computer readable medium, known now or in the future. Examples of computer readable mediums include, but are not limited to, primary storage devices (e.g., any type of random access memory) and secondary storage devices (e.g., hard drives, floppy disks, CD ROMS, zip disks, tapes, magnetic storage devices, optical storage devices, MEMs, nanotechnology-based storage device, etc.).

### D. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for providing a commercial incentive to a user of a computer, comprising:
tracking behavior of the user when interacting with an information retrieval system via a user interface of the computer;
selectively presenting a commercial incentive for display to the user via the user interface of the computer based on the tracked behavior, and
facilitating redemption of the commercial incentive on behalf of the user responsive to determining that the user has activated an interactive component of the commercial incentive when displayed via the user interface of the computer.

2. The method of claim 1, wherein tracking the behavior of the user when interacting with the information retrieval system comprises tracking an amount of time that the user spends browsing search results generated by the information retrieval system, and
wherein selectively presenting the commercial incentive for display to the user based on the tracked behavior comprises presenting the commercial incentive for display to the user responsive to at least determining that the tracked amount of time exceeds a predefined amount of time.

3. The method of claim 1, wherein tracking the behavior of the user when interacting with the information retrieval system comprises tracking a number of search requests that have been submitted by the user to the information retrieval system, and
wherein selectively presenting the commercial incentive for display to the user based on the tracked behavior comprises presenting the commercial incentive for display to the user responsive to at least determining that the tracked number of search requests exceeds a predefined number of search requests.

4. The method of claim 3, wherein tracking the number of search requests that have been submitted by the user to the information retrieval system comprises tracking a number of search requests that have been submitted by the user that are based on one or more keywords associated with a commercial incentive.

5. The method of claim 1, wherein presenting the commercial incentive for display to the user comprises presenting the commercial incentive within a search results page generated by the information retrieval system for display to the user, and
wherein determining that the user has activated the interactive component of the commercial incentive comprises determining that the user has activated a hyperlink.

6. The method of claim 1, further comprising:
calculating an interest level of the user based on the tracked behavior; and
determining at least one term of the commercial incentive based on the calculated interest level of the user.

7. The method of claim 6, wherein calculating the interest level of the user based on the tracked behavior comprises:
multiplying an amount of time that the user has spent browsing search results generated by the information retrieval system by a number of search requests that have been submitted by the user to the information retrieval system.

8. The method of claim 7, wherein multiplying the amount of time that the user has spent browsing search results generated by the information retrieval system by the number of search requests that have been submitted by the user to the information retrieval system comprises:
multiplying the amount of time that the user has spent browsing search results generated by the information retrieval system by a first weighting factor to generate a first result;
multiplying the number of searches that have been executed by the user using the information retrieval system by a second weighting factor to generate a second result; and
multiplying the first result by the second result.

9. The method of claim 6, wherein determining at least one term of the commercial incentive based on the calculated interest level of the user comprises:
comparing the calculated interest level value to a range of interest level values; and
assigning a value to the at least one term of the commercial incentive based on the comparison.

10. The method of claim 9, further comprising:
receiving an identification of the range of interest level values from an entity that administers the information retrieval system.

11. The method of claim 1, wherein selectively presenting a commercial incentive for display to the user via the user interface of the computer based on the tracked behavior comprises:
selectively presenting the commercial incentive for display to the user via the user interface of the computer based on the tracked behavior provided that a total number of times that the commercial incentive was previously presented for display via the user interface of the computer does not equal a predefined limit.

12. An information retrieval system, comprising:
a page server configured to enable a user to interact with the information retrieval system via a user interface of a computer and to track behavior of the user when interacting with the information retrieval system, wherein such interaction includes submitting search requests to the information retrieval system and browsing search results generated by the information retrieval system;
a search results generator configured to generate search results based on search requests submitted by the user; and
a commercial incentive server configured to select commercial incentives for display to the user based on the tracked behavior;
wherein the page server is further configured to present search results generated by the search results generator and commercial incentives selected by the commercial incentive server to the user via the user interface of the computer and to facilitate redemption of at least one commercial incentive on behalf of the user responsive to determining that the user has activated an interactive component of the at least one commercial incentive when displayed via the user interface of the computer.

13. The system of claim 12, wherein the page server is configured to track an amount of time that the user spends browsing search results presented to the user by the page server, and
wherein the commercial incentive server is configured to select a commercial incentive for display to the user responsive to at least determining that the tracked amount of time exceeds a predefined amount of time.

14. The system of claim 12, wherein the page server is configured to track a number of search requests that have been submitted by the user, and
wherein the commercial incentive server is configured to select a commercial incentive for display to the user responsive to at least determining that the tracked number of search requests exceeds a predefined number of search requests.

15. The system of claim 14, wherein the page server is configured to track a number of search requests that have been submitted by the user that are based on one or more keywords associated with a commercial incentive.

16. The system of claim 12, wherein the page server is configured to present search results generated by the search results generator and a commercial incentive selected by the commercial incentive server to the user within a search results page and to facilitate redemption of the commercial incentive on behalf of the user responsive to determining that the user has activated a hyperlink of the commercial incentive.

17. The system of claim 12, wherein the commercial incentive server is further configured to calculate an interest level of the user based on the tracked behavior and to determine at least one term of a commercial incentive based on the calculated interest level of the user.

18. The system of claim 17, wherein the commercial incentive server is configured to calculate the interest level of the user based on the tracked behavior by multiplying an amount of time that the user has spent browsing search results generated by the information retrieval system by a number of search requests that have been submitted by the user to the information retrieval system.

19. The system of claim 18, wherein the commercial incentive server is configured to multiply the amount of time that the user has spent browsing search results generated by the information retrieval system by the number of search requests that have been submitted by the user to the information retrieval system by multiplying the amount of time that the user has spent browsing search results generated by the information retrieval system by a first weighting factor to generate a first result, multiplying the number of search requests that have been submitted by the user to the information retrieval system by a second weighting factor to generate a second result, and multiplying the first result by the second result.

20. The system of claim 17, wherein the commercial incentive server is configured to compare the calculated interest level value to a range of interest level values and to assign a value to the at least one term of the commercial incentive based on the comparison.

21. The system of claim 20, wherein the commercial incentive server is further configured to receive an identification of the range of interest level values from an entity that administers the information retrieval system.

22. The system of claim 12, wherein the commercial incentive server is configured to select a commercial incentive for display to the user based on the tracked behavior provided that a total number of times that the commercial incentive was previously presented to the user via the user interface of the computer does not equal a predefined limit.

23. A method for providing a commercial incentive to a user of a computer, comprising:
determining an interest level of a user based on tracked behavior of the user when interacting with an information retrieval system via a user interface of a computer;
determining at least one term of a commercial incentive based on the determined interest level of the user; and
presenting the commercial incentive for display to the user via the user interface of the computer.

24. An information retrieval system, comprising:
a page server configured to enable a user to interact with the information retrieval system via a user interface of a computer and to track behavior of the user when interacting with the information retrieval system; and
a commercial incentive server configured to determine an interest level of the user based on the tracked behavior of the user and to determine at least one term of a commercial incentive based on the determined interest level of the user;
wherein the page server is further configured to present the commercial incentive for display to the user via the user interface of the computer.
